(19) United States
(12) Patent Application Publication
(10) Pub. No.: US 2026/0321594 A1
(43) Pub. Date: Oct. 15, 2026

(54) POSITIVE ELECTRODE MATERIAL AND SECONDARY BATTERY USING THE SAME

(71) Applicant: Nissan Motor Co., Ltd., Kanagawa (JP)

(72) Inventors: Issei Ootani, Kanagawa (JP); Wataru Ogihara, Kanagawa (JP); Misaki Fujimoto, Kanagawa (JP); Zhenguang Li, Kanagawa (JP); Daisuke Ito, Kanagawa (JP)

(73) Assignee: Nissan Motor Co., Ltd., Kanagawa (JP)

(21) Appl. No.: 19/101,222

(22) PCT Filed: Aug. 5, 2022
(86) PCT No.: PCT/IB2022/000467

§ 371 Date: Feb. 4, 2025

(51) Int. Cl. H01M 4/36; H01M 4/02; H01M 4/04; H01M 4/58; H01M 4/62

(52) U.S. Cl. CPC H01M 4/366; H01M 4/0471; H01M 4/5815; H01M 4/625; H01M 2004/021; H01M 2004/028

(57) ABSTRACT

A sulfur-containing positive electrode material that improves charge-discharge characteristics in a secondary battery is provided. The positive electrode material includes a conductive material having pores and a coating layer including a phosphorus sulfide and/or a discharge product thereof. The coating layer covers at least a part of a surface of the conductive material and is deposited inside the pores. A mass ratio (P/S) of a phosphorus element to a sulfur element contained in the positive electrode material is more than 0 and 0.38 or less.

### TECHNICAL FIELD

The present invention relates to a positive electrode material and a secondary battery using the same.

### BACKGROUND ART

In recent years, research and development on an all-solid-state lithium secondary battery using an oxide-based or sulfide-based solid electrolyte as an electrolyte have been actively conducted. The solid electrolyte is a material mainly composed of an ion conductor capable of ion conduction in a solid. In general, when a positive electrode material having a high potential and a large capacity and a negative electrode material having a large capacity are used, the power density and the energy density of the battery can be significantly improved. For example, elemental sulfur (S₈) has the advantage of having an extremely large theoretical capacity, being low cost and rich in resources.

On the other hand, since the elemental sulfur has high resistance, it is difficult to secure a sufficient charge-discharge capacity when the elemental sulfur is used at a practical current as a positive electrode material. In order to cope with such a problem, JP 2010-95390 A proposes a technique of using a mesoporous carbon composite material containing at least mesoporous carbon and sulfur disposed in mesopores of the mesoporous carbon as a positive electrode material of an all-solid-state lithium secondary battery. According to JP 2010-95390 A, by using a positive electrode material having such a configuration, an electron conductivity may be improved by atomization of sulfur and formation of a composite with the mesoporous carbon, and battery characteristics may be improved.

### SUMMARY OF INVENTION

However, as a result of examination by the present inventors, it has been found that even when the positive electrode material described in JP 2010-95390 A is used, sufficient charge-discharge characteristics are still not obtained.

Therefore, an object of the present invention is to provide a means capable of improving charge-discharge characteristics in a secondary battery using a sulfur-containing positive electrode material.

The present inventors have conducted intensive studies in order to solve the above problem. As a result, the present inventors have found that the above-described problem may be solved by disposing a phosphorus sulfide and/or a discharge product thereof on a surface of a conductive material having pores and inside the pores to form a positive electrode material having a P/S mass ratio of a specific value, and have completed the present invention.

One aspect of the present invention is a positive electrode material including: a phosphorus-containing component consisting of a phosphorus sulfide and/or a discharge product thereof; and a conductive material having pores, in which the phosphorus-containing component covers at least a part of a surface of the conductive material and is disposed inside the pores to form a coating layer, and a mass ratio (P/S) of a phosphorus element to a sulfur element contained in the positive electrode material is more than 0 and 0.38 or less.

### BRIEF DESCRIPTION OF DRAWINGS

FIG. 1 is a schematic cross-sectional view of a flat laminate type all-solid-state lithium secondary battery according to one embodiment of the present invention.

FIG. 2 is a Raman spectrum obtained by microscopic Raman spectroscopic analysis for the positive electrode materials produced in Example 3 and Example 12.

### DESCRIPTION OF EMBODIMENTS

Hereinafter, embodiments of the present invention described above will be described with reference to the drawings, but the technical scope of the present invention should be determined on the basis of the description of the claims, and is not limited only to the following embodiments. Note that dimensional ratios in the drawings are exaggerated for convenience of description, and may be different from actual ratios. Hereinafter, the present invention will be described by exemplifying a laminate type (internally parallel connection type) all-solid-state lithium secondary battery which is one embodiment of a secondary battery.

One aspect of the present invention is a positive electrode material including: a phosphorus-containing component consisting of a phosphorus sulfide and/or a discharge product thereof; and a conductive material having pores, in which the phosphorus-containing component covers at least a part of a surface of the conductive material and is disposed inside the pores to form a coating layer, and a mass ratio (P/S) of a phosphorus element to a sulfur element contained in the positive electrode material is more than 0 and 0.38 or less. According to the present invention, in a secondary battery using a sulfur-containing positive electrode material, charge-discharge characteristics may be improved.

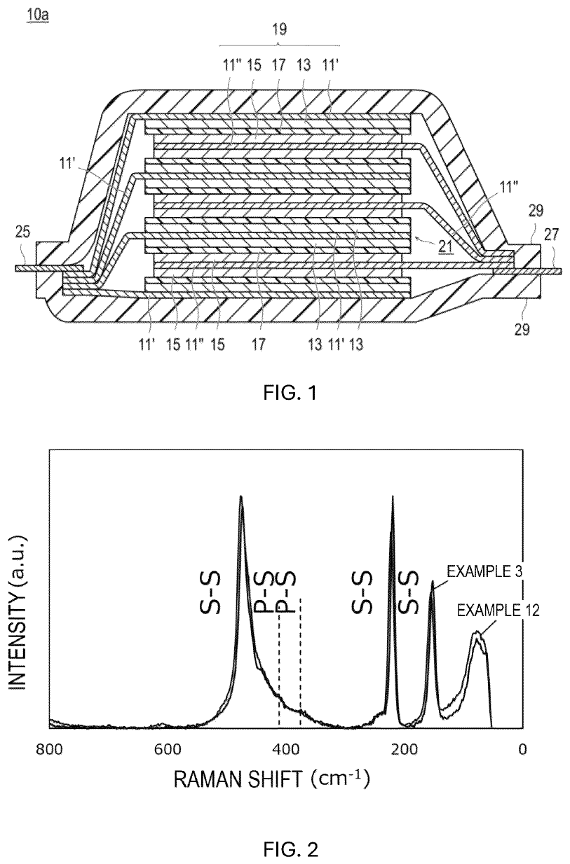

FIG. 1 is a schematic cross-sectional view of a flat laminate type all-solid-state lithium secondary battery according to one embodiment of the present invention. By adopting the laminate type, the battery can be made compact and have a high capacity. Note that in the present description, a flat laminate type lithium secondary battery (hereinafter, also simply referred to as a “laminate type battery”) that is not a bipolar type illustrated in FIG. 1 will be described in detail as an example. Here, when considered in terms of an electrical connection form (electrode structure) inside the lithium secondary battery according to the present embodiment, the present invention may be applied to both a non-bipolar type (internal parallel connection type) battery and a bipolar type (internal series connection type) battery.

In one embodiment, a laminate type battery 10a has a rectangular flat shape. A power generating element 21 is wrapped in a battery outer casing material (laminate film 29) of the laminate type battery 10a, and the periphery of the battery outer casing material is heat-sealed, and the power generating element 21 is hermetically sealed in a state where a negative electrode current collecting plate 25 and a positive electrode current collecting plate 27 are extended to the outside.

As shown in FIG. 1, the laminate type battery 10a of the present embodiment has a structure in which the flat and substantially rectangular power generating element 21 in which a charge-discharge reaction actually proceeds is sealed inside the laminate film 29 which serves as the battery outer casing material. Here, the power generating element 21 has a configuration in which a positive electrode, a solid electrolyte layer 17, and a negative electrode are laminated. The positive electrode has a structure in which a positive electrode active material layer 15 containing the positive electrode material according to one aspect of the present invention is disposed on both surfaces of a positive electrode current collector 11″. Accordingly, in the laminate type battery 10a, charge-discharge characteristics may be improved. The negative electrode has a structure in which a negative electrode active material layer 13 containing a negative electrode active material is disposed on both surfaces of a negative electrode current collector 11′. Specifically, the positive electrode, the solid electrolyte layer, and the negative electrode are laminated in this order in such a manner that one positive electrode active material layer 15 and the negative electrode active material layer 13 adjacent thereto face each other with the solid electrolyte layer 17 interposed therebetween. Thereby, the adjacent positive electrode, solid electrolyte layer, and negative electrode constitute one single battery layer 19. Therefore, it can be said that the laminate type battery 10a illustrated in FIG. 1 has a configuration in which a plurality of single battery layers 19 is laminated to be electrically connected in parallel.

The negative electrode current collector 11′ and the positive electrode current collector 11″ have a structure in which a negative electrode current collecting plate (tab) 25 and a positive electrode current collecting plate (tab) 27 which are electrically connected to the respective electrodes (positive electrode and negative electrode) are respectively attached, and the negative electrode current collecting plate and the positive electrode current collecting plate are led out to the outside of the laminate film 29 in such a manner of being sandwiched between end parts of the laminate film 29 which serves as the battery outer casing material. The positive electrode current collecting plate 27 and the negative electrode current collecting plate 25 may be attached to the positive electrode current collector 11″ and the negative electrode current collector 11′ of each electrode by ultrasonic welding, resistance welding, or the like via a positive electrode lead and a negative electrode lead (not illustrated), respectively, as necessary.

Hereinafter, main constituent members of the secondary battery according to the present embodiment will be described.

### [Current Collector]

The current collector has a function of mediating transfer of electrons from an electrode active material layer. The constituent material of the current collector is not particularly limited, and for example, a metal or a resin having conductivity may be adopted.

### [Negative Electrode (Negative Electrode Active Material Layer)]

The negative electrode active material layer contains a negative electrode active material. The type of the negative electrode active material is not particularly limited, and examples thereof include a carbon material, a metal oxide, and a metal active material. As the negative electrode active material, a silicon-based negative electrode active material or a tin-based negative electrode active material may be used, or metal lithium or a lithium-containing alloy may be used. Examples of the lithium-containing alloy include an alloy of Li and at least one of In, Al, Si, and Sn. In some cases, two or more kinds of negative electrode active materials may be used in combination. Note that in a case where the negative electrode active material is metal lithium or a lithium-containing alloy, the lithium secondary battery may be a so-called lithium deposition type lithium secondary battery in which lithium metal serving as the negative electrode active material is precipitated on the negative electrode current collector in the charging process.

A content of the negative electrode active material in the negative electrode active material layer is not particularly limited, and for example, is preferably within a range of 40 mass % to 99 mass %, and more preferably within a range of 50 mass % to 90 mass.

The negative electrode active material layer preferably further contains a solid electrolyte. By containing the solid electrolyte in the negative electrode active material layer, the ion conductivity of the negative electrode active material layer can be improved. Examples of the solid electrolyte include a sulfide solid electrolyte or an oxide solid electrolyte, and a sulfide solid electrolyte is preferable.

Examples of the sulfide solid electrolyte include LiI—Li₂S—SiS₂, LiI—Li₂S—P₂O₅, LiI—Li₃PO₄—P₂S₅, Li₂S—P₂S₅, LiI—Li₃PS₄, LiI—LiBr—Li₃PS₄, Li₃PS₄, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (here, m and n are positive numbers, and Z is any of Ge, Zn, and Ga), Li₂S—GeS₂, Li₂S—SiS₂—Li₃PO₄, and Li₂S—SiS₂—LiₓMO_{y} (here x and y are positive numbers, and M is any of P, Si, Ge, B, Al, Ga, and In), and the like. Note that the description of “Li₂S—P₂S₅” refers to a sulfide solid electrolyte obtained using a raw material composition containing Li₂S and P₂S₅, and the same applies to other descriptions.

The sulfide solid electrolyte may have, for example, a Li₃PS₄ skeleton, a Li₄P₂S₇ skeleton, or a Li₄P₂S₆ skeleton. Examples of the sulfide solid electrolyte having a Li₃PS₄ skeleton include LiI—Li₃PS₄, LiI—LiBr—Li₃PS₄, and Li₃PS₄. Examples of the sulfide solid electrolyte having a Li₄P₂S₇ skeleton include Li₇P₃S₁₁. Also, as the sulfide solid electrolyte, for example, LGPS represented by Li₍₄₋ₓ₎Ge₍₁₋ₓ₎PₓS₄ (x satisfies 0<x<1) or the like may be used. Among them, a sulfide solid electrolyte containing P element is preferable. Furthermore, the sulfide solid electrolyte may contain halogen (F, Cl, Br, I). In one preferred embodiment, the sulfide solid electrolyte contains LiₓPS₅X (here X is Cl, Br or I, preferably Cl).

Note that the ion conductivity (for example, Li ion conductivity) of the solid electrolyte at normal temperature (25° C.) is, for example, preferably 1×10⁻⁵ S/cm or more, and more preferably 1×10⁻⁴ S/cm or more. Note that the value of the ion conductivity of the solid electrolyte can be measured by an AC impedance method.

The content of the solid electrolyte in the negative electrode active material layer is, for example, preferably in the range of 1 mass % to 60 mass %, and more preferably in the range of 10 mass % to 50 mass.

The negative electrode active material layer may further contain at least one of a conductive aid and a binder in addition to the negative electrode active material and the solid electrolyte described above.

A thickness of the negative electrode active material layer varies depending on the configuration of the intended secondary battery, and is preferably, for example, in the range of 0.1 μm to 1000 μm.

### [Solid Electrolyte Layer]

The solid electrolyte layer is interposed between the positive electrode active material layer and the negative electrode active material layer and contains a solid electrolyte. The specific form of the solid electrolyte contained in the solid electrolyte layer is not particularly limited, and the solid electrolyte exemplified in the section of the negative electrode active material layer and the preferred form thereof may be similarly employed. The solid electrolyte layer may further contain a known binder in addition to the solid electrolyte.

The thickness of the solid electrolyte layer varies depending on the configuration of the intended lithium secondary battery, and is preferably 1000 μm or less, more preferably 800 μm or less, and still preferably 600 μm or less from the viewpoint that the volume energy density of the battery may be improved. On the other hand, the lower limit value of the thickness of the solid electrolyte layer is not particularly limited, and is preferably 1 μm or more, more preferably 5 μm or more, and still preferably 10 μm or more.

### [Positive Electrode Active Material Layer]

### (Positive Electrode Material)

In the laminate type battery according to the embodiment illustrated in FIG. 1, the positive electrode active material layer contains the positive electrode material according to one aspect of the present invention. The positive electrode material includes: a phosphorus-containing component consisting of a phosphorus sulfide and/or a discharge product thereof; and a conductive material having pores, in which the phosphorus-containing component covers at least a part of a surface of the conductive material and is disposed inside the pores to form a coating layer, and a mass ratio (P/S) of a phosphorus element to a sulfur element contained in the positive electrode material is more than 0 and 0.38 or less.

As described above, JP 2010-95390 A proposes a technique of using a mesoporous carbon composite material containing at least mesoporous carbon and sulfur disposed in mesopores of the mesoporous carbon as a positive electrode material of an all-solid state battery. However, in a case where an electrode is produced using such a positive electrode material, the reaction resistance of the electrode reaction is high. This is considered to be because sulfur has low conductivity, and in addition, generates Li₂S having low ion conductivity in the vicinity of the interface between the positive electrode material and the solid electrolyte during electrode reaction, so that resistance to diffusion of lithium ions in the positive electrode material increases.

On the other hand, the positive electrode material of the present invention has a phosphorus-containing component consisting of a phosphorus sulfide and/or a discharge product thereof on a surface and inside the pores of a conductive material having pores. Both sulfur and phosphorus contained in the phosphorus-containing component may act as the positive electrode active material. Also, the phosphorus sulfide is a material having extremely low degree of lithium-ion conductivity, but may form a lithium phosphorus sulfur compound (LPS) in-situ that may function as a solid electrolyte with discharge. This reduces the diffusion resistance of lithium ions. Then, an ion conduction path advantageous for movement of lithium ions can be constructed in the positive electrode active material such as sulfur or the like, and lithium ions may be efficiently introduced into the pores of the conductive material via LPS. On the surface of the positive electrode active material located deep in the pores, not only entrance and exit of electrons via the conductive material but also entrance and exit of lithium ions from the solid electrolyte via LPS may proceed smoothly. Therefore, in the positive electrode material of the present invention, a reaction region in which the positive electrode active material, LPS, and the conductive material coexist is formed not only on the surface of the conductive material but also inside the pores, and the electrode reaction may sufficiently proceed. As a result, it is considered that the positive electrode active material present inside the pores can also be used as an active material in the electrode reaction, and the internal resistance of the battery is sufficiently reduced. As a result, it is considered that the charge-discharge characteristics of the battery are improved. According to a preferred embodiment of the present invention, the phosphorus-containing component contains both the phosphorus sulfide and the discharge product thereof. Preferably, the phosphorus-containing component consists of both the phosphorus sulfide and the discharge product thereof. As a result, the effect of the present invention may be more remarkably obtained. According to another embodiment of the present invention, the phosphorus-containing component consists of the phosphorus sulfide.

Here, it is possible to confirm whether the phosphorus sulfide and/or the discharge product thereof is disposed on the surface and inside the pores of the conductive material by using various conventionally known methods. For example, with respect to an observation image of a cross section of a conductive material by a transmission electron microscope (TEM), element mapping derived from each material is performed using energy dispersive X-ray spectroscopy (EDX), and an arrangement form of each material can be confirmed using the obtained element map or the number of counts of elements derived from each material with respect to the number of counts of all elements as an index.

In the positive electrode material of the present embodiment, the mass ratio (P/S) of the phosphorus element to the sulfur element contained in the positive electrode material is more than 0 and 0.38 or less. When the P/S ratio is 0, LPS formation associated with discharge does not occur, so that the effect of the present invention cannot be obtained. On the other hand, when the P/S ratio exceeds 0.38, the sulfur element that may act as a positive electrode active material is reduced, and therefore the effect of the present invention may not be obtained.

(Phosphorus-containing Component Consisting of Phosphorus Sulfide and/or Discharge Product Thereof)

The phosphorus sulfide is preferably the phosphorus sulfide represented by PₓS_{y}. Here, x and y are positive numbers, respectively. Examples of the phosphorus sulfide include, but are not limited to, P₂S₃, P₂S₅ (P₄S₁₀), P₄S₃, P₄S₅, P₄S₇, P₄S₉, and the like. Two or more of these may be used in combination.

The discharge product of the phosphorus sulfide is not particularly limited, and examples thereof include LPS such as Li₃PS₄, Li₄P₂S₇, Li₄P₂S₆, Li₇P₃S₁₁, and the like.

(Elemental Sulfur and/or Discharge Product Thereof)

The positive electrode material of the present invention preferably further contains an elemental sulfur and/or a discharge product thereof in addition to a phosphorus-containing component consisting of a phosphorus sulfide and/or a discharge product thereof as a coating layer. The Elemental sulfur is an extremely high capacity positive electrode active material. Therefore, according to this aspect, a positive electrode material having a higher capacity may be obtained. In addition, the in-situ formation reaction of LPS may proceed more efficiently. Therefore, the resistance reduction effect may be more remarkably obtained. Preferably, the positive electrode material further contains both an elemental sulfur and a discharge product thereof. As a result, the effect of the present invention may be more remarkably obtained. In a preferred embodiment of the present invention, the phosphorus sulfide and the elemental sulfur contained in the positive electrode material may constitute a mixture having a composition of PₓS_{y} as a whole. At this time, X and Y are positive numbers, respectively. X and Y can take any positive value regardless of the stoichiometric ratio, depending on the composition of the mixture.

Here, the elemental sulfur acts as a high capacity positive electrode active material, and can release lithium ions during charge and occlude lithium ions during discharge by oxidation-reduction reaction of sulfur. In addition, the elemental sulfur can be easily carried on the conductive material by melting. As the elemental sulfur, α-sulfur, β-sulfur, or γ-sulfur having an S₈ structure may be used. The elemental sulfur may be present in the positive electrode material in the form of a (multiple) sulfide of lithium by occluding lithium ions during discharge. That is, examples of the discharge product of the elemental sulfur include lithium (multiple) sulfide such as Li₂S or the like. Note that the discharge product of the phosphorus sulfide and the discharge product of the elemental sulfur may be the same.

In a preferred embodiment of the present invention, the positive electrode material contains a phosphorus sulfide, an elemental sulfur and discharge products of these. By containing the phosphorus sulfide and the elemental sulfur, the LPS is effectively generated by discharge, and excessive sulfur may serve as a positive electrode active material to contribute to the charge-discharge reaction of the battery. As a result, a positive electrode material having a higher capacity and a further reduced reaction resistance may be obtained. A charge-discharge reaction formula estimated in a case of using elemental sulfur and phosphorus pentasulfide serving as the phosphorus sulfide is shown below.

### [Chemical Formula 1]

LPS formation reaction;

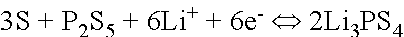

Charge-discharge reaction of excessive S;

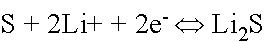

Note that the positive electrode material of the present embodiment can achieve high charge-discharge capacity and low resistance without using a solid electrolyte as a raw material, but a solid electrolyte may be further used as a raw material in addition to the phosphorus sulfide or the elemental sulfur. As described later, the positive electrode material of the present embodiment can be produced by melt-impregnating a conductive material with the phosphorus sulfide together with the positive electrode active material such as sulfur or the like. At this time, when a solid electrolyte is used as a raw material, the solid electrolyte is not melt-impregnated, and thus is hardly disposed in the surface recesses or pores of the conductive material. Therefore, the resistance reduction effect by adding the solid electrolyte may not be sufficiently obtained. When the addition amount of the solid electrolyte is increased, the resistance tends to be reduced, but when the content of the solid electrolyte is higher, the proportion of the positive electrode active material may be relatively reduced, and the energy density may be reduced. Therefore, the positive electrode material of the present embodiment preferably does not contain a solid electrolyte other than the discharge product from the viewpoint of energy density. In one embodiment, the positive electrode material does not contain a solid electrolyte having a lithium-ion conductivity at normal temperature (25° C.) of 1×10⁻⁵ S/cm or more other than the discharge product.

The positive electrode material of the present embodiment has a coating layer having a phosphorus-containing component consisting of a phosphorus sulfide and/or a discharge product thereof on the surface and inside the pores of the conductive material. Preferably, the positive electrode material of the present embodiment has a coating layer having a phosphorus-containing component and an elemental sulfur and/or a discharge product thereof on the surface and inside the pores of the conductive material. In one embodiment, the positive electrode material has a coating layer having a phosphorus-containing component consisting of a phosphorus sulfide and a discharge product thereof and an elemental sulfur and a discharge product thereof on the surface and inside the pores of the conductive material. In another embodiment, the positive electrode material has a coating layer consisting of a phosphorus sulfide and an elemental sulfur on the surface and inside the pores of the conductive material.

The coating layer is preferably substantially composed of a phosphorus-containing component and an elemental sulfur and/or a discharge product thereof, but is not limited thereto. For example, the coating layer may contain elemental phosphorus or a discharge product thereof. In addition, a component containing an element other than the lithium element, the sulfur element, or the phosphorus element may be contained. Examples of such a component include an organic sulfur compound or an inorganic sulfur compound serving as a positive electrode active material containing sulfur other than the elemental sulfur. Examples of the organic sulfur compound include a disulfide compound, a sulfur-modified polyacrylonitrile, a sulfur-modified polyisoprene, rubeanic acid (dithiooxamide), a polycarbon sulfide, and the like. Examples of the inorganic sulfur compound include TiS₂ and FeS₂. In addition, a phosphorus oxide, a lithium halide (for example, LiCl, LiBr, LiI), and the like may be contained as a component containing an element other than the lithium element, the sulfur element, or the phosphorus element. Further, discharge products of these components may be contained. At this time, the proportion of the phosphorus-containing component and the elemental sulfur and/or the discharge product thereof to the total amount of 100 mass % of the coating layer is preferably more than 50 mass %, more preferably 70 mass % or more, still preferably 90 mass % or more, still more preferably 95 mass % or more, particularly preferably 98 mass % or more, and most preferably 100 mass.

Note that in a preferred embodiment of the present invention, the component constituting the coating layer does not contain a halogen element. In a preferred embodiment of the present invention, the component constituting the coating layer does not contain an element other than the lithium element, the sulfur element, and the phosphorus element.

In the positive electrode material of the present embodiment, the mass ratio (P/S) of the phosphorus element to the sulfur element contained in the positive electrode material is not limited as long as it is more than 0 and 0.38 or less, but is preferably 0.24 or less. Within the above range, excessive phosphorus sulfide is reduced in the in-situ LPS generation reaction associated with discharge. Since the phosphorus sulfide has neither ion conductivity nor electron conductivity, the remaining phosphorus sulfide is not excessively increased, and therefore the resistance reduction effect may be more remarkably obtained. The P/S ratio is more preferably 0.20 or less, still preferably 0.14 or less, and still more preferably 0.10 or less. The P/S ratio is not particularly limited as long as it exceeds 0, but is preferably 0.03 or more because the LPS can be sufficiently generated, more preferably 0.05 or more, still preferably 0.07 or more, and still more preferably 0.08 or more. The P/S ratio can be controlled by adjusting the type and mixing ratio of the phosphorus sulfide and the elemental sulfur.

### (Conductive Material Having Pores)

The positive electrode material according to the present embodiment contains a conductive material having pores. The conductive material having pores is not particularly limited, but is preferably a conductive porous body. By using the conductive porous body, the pores are filled with the phosphorus-containing component inside, and the conductivity of the positive electrode material may be further improved. In particular, when an elemental sulfur and/or a discharge product thereof are further introduced into the pores, a positive electrode material having a higher capacity can be obtained. A material constituting the conductive material is also not particularly limited, and materials such as a metal, a conductive polymer, a carbon material, and the like can be appropriately adopted. Among them, the conductive material is preferably made of a carbon material from the viewpoint of excellent conductivity and easy processing. More preferably, the conductive material is a conductive porous body made of a carbon material.

Examples of the conductive porous body made of a carbon material include activated carbon, carbon black such as Ketjen Black (registered trademark) (highly conductive carbon black), (oil) furnace black, channel black, acetylene black, thermal black, and lamp black, and carbon particles (carbon carriers) made of coke, natural graphite, artificial graphite, and the like. In addition, it is also possible to use commercially available porous carbon such as CNovel (registered trademark) manufactured by Toyo Tanso Co., Ltd., or the like which has many mesopores and has communication holes in which the mesopores are connected to each other. In addition, a mold such as ceramics or the like and a carbon raw material such as a resin or the like are mixed and fired in an inert atmosphere, and then the mold is melted with an acid to synthesize a conductive porous body having a porous structure to which the shape of the mold is transferred, and the conductive porous body may be used. At this time, the pore diameter and the pore volume of the obtained conductive porous body can be changed by appropriately adjusting the particle diameter of the mold and the blending ratio of the carbon raw materials. Among them, activated carbon or porous carbon having communication holes in which mesopores are connected to each other may be preferably used.

Note that the carbon material preferably contains carbon as a main component. Here, the phrase “contains carbon as a main component” means that carbon atoms are contained as a main component, and includes the concept of consisting only of carbon atoms and the concept of consisting substantially of carbon atoms. The phrase “consisting substantially of carbon atoms” means that impurities of about 2 mass % to 3 mass % or less can be allowed to be mixed. Note that in the present specification, a particulate carbon material whose main component is carbon is referred to as porous carbon particles.

A BET specific surface area of the conductive material is preferably 500 m²/g or more, more preferably 800 m²/g or more, still preferably 1200 m²/g or more, and particularly preferably 1500 m²/g or more. A pore volume of the conductive material is preferably 1.0 mL/g or more, more preferably 1.3 mL/g or more, and still preferably 1.5 mL/g or more. When the BET specific surface area and the pore volume of the conductive material are values within such ranges, it is possible to retain a sufficient amount of pores, which in turn makes it possible to retain a sufficient amount of the phosphorus-containing component and, when contained, an elemental sulfur and/or a discharge product thereof. In addition, since an average thickness of the coating layer covering the conductive material does not become too thick, sufficient conductivity can be easily secured, which is preferable. The BET specific surface area of the conductive material is not particularly limited, and is preferably 3100 m²/g or less, more preferably 3000 m²/g or less, still preferably 2500 m²/g or less, and particularly preferably 2000 m²/g or less. Within the above range, the coating layer can be formed more uniformly, so that the battery reaction may proceed more efficiently. Note that the values of the BET specific surface area and the pore volume of the conductive material can be measured by nitrogen adsorption/desorption measurement. This nitrogen adsorption/desorption measurement is performed using BELSORPmini manufactured by MicrotracBEL Corp., and is performed by a multipoint method at a temperature of −196° C. The BET specific surface area is determined from the adsorption isotherm in the relative pressure range of 0.01<P/P₀<0.05. The pore volume is determined from the volume of the adsorbed N₂ at a relative pressure of 0.96.

An average pore diameter of the conductive material is not particularly limited, and is preferably 1 nm to 50 nm, and more preferably 1 nm to 30 nm. When the average pore diameter of the conductive material is within these ranges, electrons can be sufficiently supplied to the phosphorus-containing component or the elemental sulfur and/or the discharge product thereof present at a position away from the pore wall inside the pores. Note that the value of the average pore diameter of the conductive material can be calculated by nitrogen adsorption/desorption measurement as in the case of determining the values of the BET specific surface area and the pore volume. In the present description, the pore distribution of the conductive material obtained using the BJH method is adopted.

The conductive material is not particularly limited, but among pores of the conductive material, a percentage of a pore volume of pores having a pore diameter in a range of 1 nm to 4 nm to a pore volume of pores having a pore diameter in a range of 1 nm to 100 nm is preferably 20% or less. As a result, the phosphorus-containing component and the elemental sulfur and/or the discharge product thereof serving as the positive electrode active material may be easily held up to the inside of the pores. As a result, it is considered that the internal resistance of the battery is further reduced. Note that the value of the percentage is more preferably 18% or less, still preferably 15% or less, still more preferably 12% or less, and particularly preferably 9%. On the other hand, the lower limit value of the percentage is not particularly limited, and is, for example, 3% or more.

An average particle diameter (primary particle diameter) of the conductive material is not particularly limited, and is preferably 0.05 μm to 50 μm, more preferably 0.1 μm to 20 μm, and still preferably 0.5 μm to 10 μm. Note that in the present description, the “particle diameter of the conductive material” means the maximum distance L among the distances between any two points on the outline of the conductive material. As the value of the “average particle diameter of the conductive material”, a value calculated as an arithmetic average value of particle diameters of particles observed in several to several tens of fields of view using an observation means such as a scanning electron microscope (SEM), a transmission electron microscope (TEM), or the like is adopted.

An amount of the conductive material having pores is not particularly limited, and is preferably 0.05 to 10, more preferably 0.1 to 5, still preferably 0.15 to 2, and still more preferably 0.2 to 2 in terms of a mass ratio with respect to the phosphorus sulfide (the total amount of the phosphorus sulfide and the elemental sulfur in a case where the elemental sulfur is further used). When the amount of the conductive material is within the above range, a positive electrode material having sufficient conductivity can be obtained. Note that in the positive electrode material of the present embodiment, a discharge product is formed from at least a part of the phosphorus sulfide (the phosphorus sulfide and the elemental sulfur in a case where the elemental sulfur is contained) associated with discharge, but it is preferable to satisfy the above range in both states before and after discharge and before and after charge. In a preferred embodiment, the amount of the conductive material is, for example, 10 mass % to 20 mass % and preferably 11 mass % to 19 mass with respect to a total amount of the phosphorus sulfide, the elemental sulfur, and the conductive material in terms of a preparation ratio.

In the positive electrode material of the present invention, the average thickness of the coating layer coating the surface of the conductive material is preferably 5 nm or less. With this configuration, the effect of the present invention can be more remarkably obtained. It is considered that, although the phosphorus sulfide does not have electron conductivity, when the average thickness of the coating layer is 5 nm or less, electrons are supplied to the conductive material by the tunnel effect, and low reaction resistance may be maintained. The average thickness of the coating layer is preferably 4 nm or less, still preferably 3 nm or less, and still more preferably 2 nm or less. The average thickness of the coating layer is not particularly limited, and is, for example, 0.1 nm or more, preferably 0.5 nm or more, still preferably 0.8 nm or more, and still more preferably 1.0 nm or more. Within the above range, the coating layer can be formed more uniformly, so that the battery reaction may proceed more efficiently, and the charge-discharge characteristics may be further improved. Note that the average thickness can be obtained by the method described in Examples. The average thickness can be controlled by adjusting the type and mixing ratio of components such as the conductive material, the phosphorus sulfide, the elemental sulfur, and the like. In addition, in the positive electrode material of the present embodiment, a discharge product is formed from at least a part of the phosphorus sulfide and the elemental sulfur associated with discharge, but it is preferable to satisfy the above range in both states before and after discharge and before and after charge.

### (Production Method by Batch Heat Impregnation)

The positive electrode material according to the present embodiment may be produced by a production method (production method by batch heat impregnation) including a step of heat-treating a mixture containing a conductive material having pores, a phosphorus sulfide, and an elemental sulfur.

At this time, specific forms of the conductive material having pores, the phosphorus sulfide, and the elemental sulfur are as described above. The mixing ratio of the conductive material having pores, the phosphorus sulfide and the elemental sulfur is not particularly limited, and may be adjusted in such a manner that the mass ratio (P/S) of the phosphorus element to the sulfur element in the obtained positive electrode material is more than 0 and 0.38 or less.

For example, a preparation ratio of elemental sulfur:phosphorus sulfide may be elemental sulfur:phosphorus sulfide=17.25:1 to 0.75:1, and may be preferably 6:1 to 2:1. In one embodiment, the preparation ratio may be S:P₂S₅=69:1 to 3:1 in terms of S:P₂S₅.

A specific means for mixing the conductive material having pores, the phosphorus sulfide, and the elemental sulfur is not particularly limited, and conventionally known knowledge can be appropriately referred to. Examples thereof include a mixing treatment using a mixing means such as a mortar or the like and a milling treatment using a grinding means such as a planetary ball mill or the like.

Note that the step of mixing the above components is preferably performed under an inert gas atmosphere with a dew point controlled. For example, the step may be performed under an inert gas atmosphere having a dew point of −60° C. or lower.

A temperature of the heat treatment is not particularly limited, and is preferably a temperature equal to or higher than the melting point of the material to be used. For example, the temperature is higher than 170° C., preferably 200° C. or higher, more preferably 250° C. or higher, still preferably 290° C. or higher, and still more preferably 300° C. or higher. On the other hand, the upper limit value of the heat treatment temperature is also not particularly limited, and is, for example, 500° C. or lower, preferably 400° C. or lower. A heat treatment time is also not particularly limited, and is, for example, 0.5 hours to 20 hours, preferably 1 hour to 10 hours. It is considered that by doing so, the phosphorus sulfide and the elemental sulfur are melted and mixed to form a phosphorus polysulfide composition PₓS_{y}, and formation of a composite with the conductive material proceeds in a molten state. As a result, it is considered that the phosphorus sulfide and the elemental sulfur may be introduced onto the surface and into pores of the conductive material not in a respectively separated state but in a state of having a homogeneous composition of PₓS_{y}s. Therefore, the reaction resistance is reduced, and a positive electrode material having excellent charge-discharge characteristics may be obtained.

The heat treatment is preferably performed under reduced pressure.

It is preferable to perform the heat treatment under reduced pressure because the residual gas in the pores of the conductive material can be removed. The heat treatment is not particularly limited, and can be performed under reduced pressure of, for example, 100 Pa or less, preferably 10 Pa or less.

The positive electrode material thus obtained can generate the LPS as a discharge product from at least a part of the phosphorus polysulfide composition PₓS_{y} inside the positive electrode material by discharge. A specific procedure of the discharge is not particularly limited, and the discharge can be performed by a general method.

### (Production Method by Sequential Heat Impregnation)

The positive electrode material according to the present embodiment may be produced by a production method (production method by sequential heat impregnation) including: a step of heat-treating a conductive material having pores and an elemental sulfur to cause the conductive material to support the elemental sulfur in a gas phase; and a step of mixing a phosphorus sulfide with the conductive material on which the elemental sulfur is supported in the gas phase, and further performing a heat treatment.

In this method, the elemental sulfur is first supported on the conductive material by a vapor-phase support in a sublimated state. This allows a homogeneous coating onto the surface and into the pores of the conductive material. Therefore, an excellent electron conduction path for the sulfur can be constructed. Thereafter, the phosphorus sulfide is mixed with the conductive material on which the sulfur is supported, and a heat treatment is further performed. This is considered to cause the phosphorus sulfide to melt and diffuse into the sulfur which is already supported to form a homogeneous PₓS_{y} composition. Here, the elemental sulfur has a lower sublimation point than a mixture obtained by mixing the elemental sulfur and the phosphorus sulfide in advance, and can be supported in the gas phase. It is considered that by supporting the elemental sulfur in the gas phase, more uniform coating becomes possible, and the reaction interface area increases. Therefore, it is considered that even when the amounts of the elemental sulfur and the phosphorus sulfide used are about the same, the reaction resistance can be further reduced, and the charge-discharge characteristics can be further improved.

The heat treatment temperature in the step of causing the conductive material having pores to support the elemental sulfur in the gas phase is not particularly limited, and is, for example, 150° C. to 250° C., more preferably 150° C. to 200° C., and still preferably 150° C. to 180° C. The heat treatment time is also not particularly limited, and is, for example, 1 hour to 5 hours. The heat treatment can be performed under the same conditions as those of the heat treatment in the production method by batch heat impregnation except for the above.

The heat treatment conditions in the step of mixing the phosphorus sulfide with the conductive material on which the elemental sulfur is supported in the gas phase and further performing the heat treatment can be the same as the heat treatment in the production method by batch heat impregnation. The specific means for mixing the phosphorus sulfide with the conductive material on which the elemental sulfur is supported in the gas phase is also the same as described above.

Note that as specific forms, the forms similar to those in the production method by batch heat impregnation can be preferably adopted, except that the elemental sulfur is supported on the conductive material by heat impregnation, and then the phosphorus sulfide is supported by heat impregnation.

Note that it is not possible to dispose the components such as the phosphorus sulfide, the elemental sulfur, and the like inside the pores of the conductive material simply by mechanically mixing the above-described components such as the phosphorus sulfide, the elemental sulfur, and the like with the conductive material having pores in a solid state. In this case, the components such as the phosphorus sulfide and the elemental sulfur and the like only adhere to the surfaces of the particles of the conductive material. Therefore, the discharge products of these components are also not disposed inside the pores of the conductive material, and only adhere to the surfaces of the particles of the conductive material.

The production method of the present embodiment can be carried out without using a solid electrolyte as a raw material, and in a preferred embodiment, the solid electrolyte is not used as a raw material. In a positive electrode material in which a solid electrolyte is used as a raw material and is supported on a conductive material together with, for example, a positive electrode active material or the like, a peak corresponding to PS₄³⁻ derived from the solid electrolyte may be remarkably observed in the vicinity of 420 cm⁻¹ in a Raman spectrum of microscopic Raman spectrometry using a laser with a wavelength of 532 nm. In particular, in a case of having a step of dissolving and reprecipitating the solid electrolyte using a solvent, a peak corresponding to a decomposition product of the solid electrolyte such as PSₓO_{y}ⁿ⁻ (side reaction product between the solid electrolyte and the solvent) may be remarkably observed in the range of 1300 cm⁻¹ to 1700 cm⁻¹. On the other hand, in the positive electrode material of the present embodiment in which the solid electrolyte is not used as a raw material, a strong peak corresponding to PS₄³⁻ derived from the solid electrolyte in the vicinity of 420 cm⁻¹ is less likely to occur. In addition, since no solvent is used, no peak corresponding to the decomposition product of the solid electrolyte in the range of 1300 cm⁻¹ to 1700 cm⁻¹ occurs. Note that in the positive electrode material of the present embodiment, even after discharging, no peak corresponding to the decomposition product of the solid electrolyte in the range of 1300 cm⁻¹ to 1700 cm⁻¹ is observed.

A content of the positive electrode material of the present embodiment in the positive electrode active material layer is not particularly limited, and for example, is preferably within a range of 35 mass % to 99 mass %, and more preferably within a range of 40 mass % to 90 mass %. Note that the positive electrode active material layer may further contain a known positive electrode material (positive electrode active material) in addition to the positive electrode material of the present embodiment as long as the effect of the present invention is not impaired. In the positive electrode materials contained in the positive electrode active material layer, the content of the positive electrode material of the present embodiment is preferably 90 mass % or more, and more preferably 95 mass % or more.

The positive electrode active material layer may further contain a solid electrolyte that may be contained in the negative electrode active material layer as necessary. The content of the solid electrolyte in the positive electrode active material layer is, for example, preferably in the range of 1 mass % to 65 mass %, and more preferably in the range of 10 mass % to 50 mass %. In addition, the positive electrode active material layer may further contain a conductive aid and/or a binder.

The thickness of the positive electrode active material layer varies depending on the configuration of the intended secondary battery, and is preferably within the range of 0.1 μm to 1000 μm.

Further, the secondary battery according to the present embodiment may not be an all solid type. That is, the solid electrolyte layer may further contain a conventionally known liquid electrolyte (electrolyte solution). The amount of the liquid electrolyte (electrolyte solution) that may be contained in the solid electrolyte layer is not particularly limited, and is preferably such an amount that the shape of the solid electrolyte layer formed by the solid electrolyte is maintained and liquid leakage of the liquid electrolyte (electrolyte solution) does not occur.

Note that the following embodiments are also included in the scope of the present invention: the positive electrode material according to claim 1, having features of claim 2; the positive electrode material according to claim 1, having features of claim 3; the positive electrode material according to any one of claims 1 to 3, having features of claim 4; the positive electrode material according to any one of claims 1 to 4, having features of claim 5; the positive electrode material according to any one of claims 1 to 5, having features of claim 6; the positive electrode material according to any one of claims 1 to 6, having features of claim 7; and a secondary battery including the positive electrode material according to any one of claims 1 to 7.

### EXAMPLES

Hereinafter, the present invention will be described in more detail with reference to Examples. Here, the technical scope of the present invention is not limited only to the following examples.

### Example 1

### (Preparation of Positive Electrode Material)

In a glove box in an argon atmosphere at a dew point of −68° C. or lower, 0.440 g of sulfur (a Sulfur, S₈, manufactured by Tsurumi Chemical Industry Co., Ltd.) and 0.06 g of phosphorus pentasulfide (manufactured by Kojundo Chemical Lab. Co., Ltd.) were added to 0.100 g of porous carbon (Carbon 1, KNobel (registered trademark) P(3)010 manufactured by Toyo Tanso Co., Ltd., BET specific surface area: 1640 m²/g) as a conductive material. Here, a molar ratio of sulfur:phosphorus pentasulfide was S:P₂S₅=51:1 in terms of S:P₂S₅. After the mixture was sufficiently mixed in an agate mortar, the mixed powder was placed in a quartz container and sealed under reduced pressure at a pressure of about 4 mbar, and the container was further placed in a tubular furnace and heated at 350° C. for 6 hours to melt sulfur and phosphorus pentasulfide, so that the melted sulfur and phosphorus pentasulfide were impregnated into the porous carbon. Note that in the positive electrode material of this Example, (total mass of sulfur and phosphorus pentasulfide):(mass of porous carbon)=5:1 was set.

### Examples 2 to 8

### (Preparation of Positive Electrode Material)

In Example 1, the molar ratio of sulfur and phosphorus pentasulfide was changed as shown in the following Table 1. At this time, in each Example, (total mass of sulfur and phosphorus pentasulfide):(mass of porous carbon)=5:1 was set. Further, in Examples 7 and 8, carbon 2 (MSC-30 manufactured by Kansai Coke and Chemicals Company, Limited, BET specific surface area: 3040 m²/g) and carbon 3 (xGnP graphene nanoplatelets-grade C-500 manufactured by Merck & Co., Inc., BET specific surface area: 500 m²/g) were used in place of carbon 1, respectively. The positive electrode material was produced in the same manner as in Example 1 except for the above.

### Example 9

### (Preparation of Positive Electrode Material)

In a glove box in an argon atmosphere at a dew point of −68° C. or lower, 0.454 g of sulfur (a Sulfur, S₈, manufactured by Tsurumi Chemical Industry Co., Ltd.) was added to 0.100 g of porous carbon (Carbon 1, KNobel (registered trademark) P(3)010 manufactured by Toyo Tanso Co., Ltd., BET specific surface area: 1640 m²/g) as a conductive material, and the mixture was sufficiently mixed in an agate mortar. Thereafter, the mixed powder was placed in a sealed pressure-resistant autoclave container, and heated at 170° C. for 3 hours to melt sulfur, so that the melted sulfur was impregnated into the porous carbon, and sulfur impregnated porous carbon was obtained.

In a glove box in an argon atmosphere at a dew point of −68° C. or lower, 0.046 g of phosphorus pentasulfide (manufactured by Kojundo Chemical Lab. Co., Ltd.) was added to 0.554 g of the sulfur impregnated porous carbon prepared above. Here, the molar ratio of sulfur:phosphorus pentasulfide was S:P₂S₅=69:1. After the mixture was sufficiently mixed in an agate mortar, the mixed powder was placed in a quartz container and sealed under reduced pressure at a pressure of about 4 mbar, and the container was then placed in a tubular furnace and heated at 350° C. for 6 hours to melt phosphorus pentasulfide to form a composite with the sulfur impregnated porous carbon, so that the positive electrode material is obtained.

### Examples 10 to 14

In (Preparation of Positive Electrode Material) of Example 9, the molar ratio of sulfur to phosphorus pentasulfide was changed as shown in the following Table 1. At this time, in each Example, (total mass of sulfur and phosphorus pentasulfide):(mass of porous carbon)=5:1 was set. The positive electrode material was produced in the same manner as in Example 9 except for the above.

### Comparative Example 1

A positive electrode material was prepared by the same method as in Example 1 except that sulfur was changed to 0.500 g and phosphorus pentasulfide was not added in (Preparation of Positive Electrode Material) of Example 1.

### Comparative Example 2

A positive electrode material was prepared by the same method as in Example 1 except that phosphorus pentasulfide was changed to 0.500 g and sulfur was not added in (Preparation of Positive Electrode Material) of Example 1.

### Comparative Example 3

### (Preparation of Positive Electrode Material)

In a glove box in an argon atmosphere at a dew point of −68° C. or lower, porous carbon (Carbon 1, KNobel (registered trademark) P(3)010 manufactured by Toyo Tanso Co., Ltd., BET specific surface area: 1640 m²/g), sulfur (α Sulfur, S₈, manufactured by Tsurumi Chemical Industry Co., Ltd.), and phosphorus pentasulfide (manufactured by Kojundo Chemical Lab. Co., Ltd.) were weighed in such a manner that the molar ratio of sulfur to phosphorus pentasulfide was 18:1 in terms of S:P₂S₅, and (total mass of sulfur and phosphorus pentasulfide):(mass of porous carbon)=5:1 was set. Each component was placed in a zirconia container having a volume of 45 mL, and treated with a planetary ball mill (Premium line P-7 manufactured by Fritsch GmbH) at 370 rpm for 6 hours to obtain a positive electrode material.

### (Average Thickness of Coating Layer)

The average thickness of the coating layer covering the conductive material was estimated for the positive electrode material prepared in each of Examples and Comparative Examples. Here, “coating” means that when the specific surface area of the conductive material is measured by the BET method, a phosphorus-containing component and an elemental sulfur and/or a discharge product thereof (when contained) serving as components constituting the coating layer adhere to a portion to which nitrogen gas is adsorbed. The average thickness was determined by the following formula.

Average thickness=(input volume of component constituting coating layer)/(BET specific surface area of conductive material) [Mathematical Formula 1]

The BET specific surface area of the conductive material was measured by nitrogen adsorption/desorption measurement. The input volume of the components constituting the coating layer was the total volume of the components constituting the coating layer input with respect to the unit mass of the conductive material, and was estimated from the preparation amount of each component, assuming that a density of sulfur (α-sulfur) is 2.07 g/cm³ and a density of phosphorus pentasulfide is 2.05 g/cm³. The results are shown in Table 1 below.

### (Micro-Raman Spectroscopic Analysis of Positive Electrode Material)

In a glove box in an argon atmosphere at a dew point of −68° C. or lower, a powder sample of the positive electrode material obtained as described above was placed on a glass plate and the surface was flattened, and Raman point measurement was performed at an excitation wavelength of 532 nm using a confocal microscopic spectroscopic analyzer (α300 manufactured by WITec GmbH). The Raman spectra of the positive electrode materials of Examples 3 and 12 thus obtained are shown in FIG. 2. As shown in FIG. 2, the Raman spectra of the positive electrode materials obtained in these Examples show peaks which are considered to be derived from a S—S bond in the range of 470 cm⁻¹ to 475 cm⁻¹, in the vicinity of 220 cm⁻¹ to 230 cm⁻¹, and in the vicinity of 155 cm⁻¹ to 165 cm⁻¹. Here, in a case where a large amount of the solid electrolyte was present, it was expected that a peak derived from a P—S bond was observed in the vicinity of 420 cm⁻¹ (for example, in the range of 385 cm⁻¹ to 430 cm⁻¹) corresponding to PS₄³⁻ which is a decomposition product of the solid electrolyte, but a remarkable peak was not observed in the positive electrode materials of these Examples. Note that when a positive electrode material was produced by a method including a step of dissolving and reprecipitating a solid electrolyte using a solvent, a peak corresponding to a decomposition product of the solid electrolyte (side reaction product between the solid electrolyte and the solvent) is observed in the range of 1300 cm⁻¹ to 1700 cm⁻¹ in the Raman spectrum of the positive electrode material, but such a peak was not observed in the positive electrode materials of these Examples (not shown).

In addition, when Raman spectra of the positive electrode materials of these Examples after discharging were separately measured, a remarkable peak was not observed in the vicinity of 420 cm⁻¹ (for example, in the range of 385 cm⁻¹ to 430 cm⁻¹). In addition, no peak corresponding to the decomposition product of the solid electrolyte in the range of 1300 cm⁻¹ to 1700 cm⁻¹ was observed.

### Preparation Example of Test Cell

### (Preparation of Positive Electrode Mixture)

In a glove box in an argon atmosphere at a dew point of −68° C. or lower, 40 g of zirconia balls with a diameter of 5 mm, 0.375 g of the positive electrode material prepared in each of Examples and Comparative Examples, and 0.125 g of a solid electrolyte (Li₆PS₅Cl manufactured by Ampcera Inc.) were put in a zirconia container with a capacity of 45 ml, and treated with a planetary ball mill (Premium line P-7 manufactured by Fritsch GmbH) at 370 rpm for 6 hours to obtain a powder of a positive electrode mixture. The composition of the positive electrode mixture was positive electrode material:solid electrolyte=75:25 (mass ratio).

(Preparation of Test Cell (All-solid-state Lithium Secondary Battery))

The battery was produced in a glove box in an argon atmosphere at a dew point of −68° C. or lower. A cylindrical convex punch (10 mm diameter) made of SUS was inserted into one side of a cylindrical tube jig (tube inner diameter: 10 mm, outer diameter: 23 mm, height: 20 mm) made of MACOR, and 80 mg of a sulfide solid electrolyte (Li₆PS₅Cl manufactured by Ampcera Inc.) was placed from the upper side of the cylindrical tube jig. Thereafter, another cylindrical convex punch made of SUS was inserted to sandwich the solid electrolyte, and the solid electrolyte was pressed at a pressure of 75 MPa for 3 minutes using a hydraulic press to form a solid electrolyte layer having a diameter of 10 mm and a thickness of about 0.6 mm in the cylindrical tube jig. Next, the cylindrical convex punch inserted from the upper side was temporarily removed, 7.5 mg of the positive electrode mixture prepared above was added to one side surface of the solid electrolyte layer in the cylindrical tube, and again, the cylindrical convex punch (also serving as a positive electrode current collector) was inserted from the upper side and pressed at a pressure of 300 MPa for 3 minutes to form a positive electrode active material layer having a diameter of 10 mm and a thickness of about 0.06 mm on the one side surface of the solid electrolyte layer. Next, the lower cylindrical convex punch (also serving as a negative electrode current collector) was removed, and as a negative electrode, a lithium foil (manufactured by The Nilaco Corporation, thickness: 0.20 mm) punched to a diameter of 8 mm and an indium foil (manufactured by The Nilaco Corporation, thickness: 0.30 mm) punched to a diameter of 9 mm were stacked and put in from the lower side of the cylindrical tube jig in such a manner that the indium foil was located on the solid electrolyte layer side. Then, the cylindrical convex punch was inserted again, and pressed at a pressure of 75 MPa for 3 minutes to form a lithium-indium negative electrode. As described above, a test cell (all-solid-state lithium secondary battery) in which a negative electrode current collector (punch), a lithium-indium negative electrode, a solid electrolyte layer, a positive electrode active material layer, and a positive electrode current collector (punch) were stacked in this order was prepared.

### <<Evaluation of Test Cell>>

For the test cells produced in the above Examples and Comparative Examples, the capacity characteristics were evaluated by the following method. Note that all the following measurements were performed in a constant temperature thermostatic bath at 25° C. using a charge-discharge test apparatus (HJ-SD8 manufactured by Meiden Hokuto Corporation).

### (Evaluation of Capacity Characteristics)

A test cell was placed in a thermostatic bath, and after the cell temperature became constant, as cell conditioning, constant current discharge was performed at a current density of 0.2 mA/cm² until the cell voltage reached 0.5 V, followed by constant current constant voltage charge of 2.5 V at the same current density with the cut-off current set to 0.01 mA/cm². This conditioning charge-discharge cycle was repeated three times, and the third discharge capacity was defined as a rated capacity. The capacity value (mAh/g-S) per mass of sulfur(S) was calculated from the value of the third discharge capacity and the mass of sulfur(S) contained in the positive electrode active material layer. In addition, the capacity value (mAh/g-positive electrode) per mass of the positive electrode mixture was calculated from the value of the third discharge capacity and the mass of the positive electrode active material layer. The results are shown in Table 1 below.

### (Evaluation of Resistance Value)

A test cell was placed in a thermostatic bath, the SOC (state of charge) of the cell was adjusted to 50%, the current density was varied to 0.2, 0.4, and 0.8 mA/cm², and discharging was performed for 10 seconds, and the resistance value was calculated from the obtained IV curve. Before voltage application at each current value, charging was performed at 0.2 mA/cm² so that SOC was 50%. The results are shown in Table 1 below.

TABLE 1

| | | | | | BET | | | | |
|---|---|---|---|---|---|---|---|---|---|
| | | | | | specific | | | | |
| | | | | | surface | | | | |
| | | | | | area of | | | Discharge | DC |
| | | | | | conduc- | Average | Discharge | capacity | Resis- |
| | | | S:P₂S₅ | P/S | tive | thick- | capacity | mAh/g- | tance |
| | Raw | Production | molar | mass | material | ness | mAh/ | positive | (10 s) |
| | material | method | ratio | ratio | m²/g | nm | g-S | electrode | Ω · cm² |
| Example 1 | S₈/P₄S₁₀/C | Batch heating | 51:1 | 0.03 | 1640 | 1.5 | 1538 | 747 | 420 |
| | | impregnation | | | | | | | |
| Example 2 | S₈/P₄S₁₀/C | Batch heating | 21:1 | 0.07 | 1640 | 1.5 | 1791 | 834 | 330 |
| | | impregnation | | | | | | | |
| Example 3 | S₈/P₄S₁₀/C | Batch heating | 18:1 | 0.08 | 1640 | 1.5 | 1906 | 879 | 281 |
| | | impregnation | | | | | | | |
| Example 4 | S₈/P₄S₁₀/C | Batch heating | 15:1 | 0.10 | 1640 | 1.5 | 1940 | 885 | 283 |
| | | impregnation | | | | | | | |
| Example 5 | S₈/P₄S₁₀/C | Batch heating | 9:1 | 0.14 | 1640 | 1.5 | 1738 | 764 | 318 |
| | | impregnation | | | | | | | |
| Example 6 | S₈/P₄S₁₀/C | Batch heating | 3:1 | 0.24 | 1640 | 1.5 | 1547 | 623 | 366 |
| | | impregnation | | | | | | | |
| Example 7 | S₈/P₄S₁₀/C | Batch heating | 18:1 | 0.08 | 3040 | 0.8 | 1756 | 810 | 360 |
| | | impregnation | | | | | | | |
| Example 8 | S₈/P₄S₁₀/C | Batch heating | 18:1 | 0.08 | 500 | 5.0 | 1292 | 596 | 476 |
| | | impregnation | | | | | | | |
| Example 9 | S₈/P₄S₁₀/C | Sequential | 69:1 | 0.03 | 1640 | 1.5 | 1530 | 746 | 378 |
| | | heat | | | | | | | |
| | | impregnation | | | | | | | |
| Example 10 | S₈/P₄S₁₀/C | Sequential | 34:1 | 0.05 | 1640 | 1.5 | 1693 | 807 | 338 |
| | | heat | | | | | | | |
| | | impregnation | | | | | | | |
| Example 11 | S₈/P₄S₁₀/C | Sequential | 23:1 | 0.07 | 1640 | 1.5 | 2062 | 965 | 297 |
| | | heat | | | | | | | |
| | | impregnation | | | | | | | |
| Example 12 | S₈/P₄S₁₀/C | Sequential | 17:1 | 0.09 | 1640 | 1.5 | 1874 | 862 | 253 |
| | | heat | | | | | | | |
| | | impregnation | | | | | | | |
| Example 13 | S₈/P₄S₁₀/C | Sequential | 14:1 | 0.10 | 1640 | 1.5 | 1929 | 875 | 255 |
| | | heat | | | | | | | |
| | | impregnation | | | | | | | |
| Example 14 | S₈/P₄S₁₀/C | Sequential | 9:1 | 0.14 | 1640 | 1.5 | 1860 | 815 | 286 |
| | | heat | | | | | | | |
| | | impregnation | | | | | | | |
| Comparative | S₈/C | Batch heating | 1:0 | 0.00 | 1640 | 1.5 | 1316 | 658 | 584 |
| Example 1 | | impregnation | | | | | | | |
| Comparative | P₄S₁₀/C | Batch heating | 0:1 | 0.39 | 1640 | 1.5 | 517 | 187 | 5073 |
| Example 2 | | impregnation | | | | | | | |
| Comparative | S₈/P₄S₁₀/C | Ball mill | 15:1 | 0.10 | 1640 | — | 1186 | 539 | 1060 |
| Example 3 | | | | | | | | | |

From the results shown in Table 1, it is found that according to the present invention, the charge-discharge characteristics may be improved in a secondary battery using a sulfur-containing positive electrode material. On the other hand, in the positive electrode material of Comparative Example 1 in which a component containing phosphorus sulfide is not used and the positive electrode material of Comparative Example 2 in which the P/S mass ratio exceeds 0.38, the reaction resistance is high, and excellent charge-discharge characteristics cannot be obtained. In addition, in the positive electrode material of Comparative Example 3 prepared by a ball mill, since a layer containing a phosphorus sulfide cannot be disposed inside pores of the conductive material, a sufficient resistance reduction effect cannot be obtained.

Comparison between Examples 1 to 8 and Examples 9 to 14 showed that the positive electrode material of Examples 9 to 14 in which the sulfur and the phosphorus sulfide were sequentially heated and impregnated had more excellent charge-discharge characteristics.

### REFERENCE SIGNS LIST

10a Laminate type battery
11′ Negative electrode current collector
11″ Positive electrode current collector
13 Negative electrode active material layer
15 Positive electrode active material layer
17 Solid electrolyte layer
19 Single battery layer
21 Power generating element
25 Negative electrode current collecting plate
27 Positive electrode current collecting plate
29 Laminate film

1. A positive electrode material comprising:
a conductive material having pores, and a coating layer comprising a phosphorus sulfide and/or a discharge product thereof, wherein:
the coating layer covers at least a part of a surface of the conductive material and is deposited inside the pores;
a mass ratio (P/S) of a phosphorus element to a sulfur element contained in the positive electrode material is more than 0 and 0.38 or less;
a BET specific surface area of the conductive material is 800 m²/g or more and 3000 m²/g or less; and
an average thickness of the coating layer is 1.0 nm or more and 4 nm or less.

2. The positive electrode material according to claim 1, wherein the coating layer comprises the phosphorus sulfide and the discharge product thereof.

3. The positive electrode material according to claim 1, wherein the coating layer comprises the phosphorus sulfide.

4. The positive electrode material according to claim 1, wherein the coating layer further comprises elemental sulfur and/or a discharge product thereof.

5. The positive electrode material according to claim 1, wherein the BET specific surface area of the conductive material is 1200 m²/g or more and 2500 m²/g or less.

6. The positive electrode material according to claim 1, wherein the mass ratio (P/S) of the phosphorus element to the sulfur element contained in the positive electrode material is 0.03 or more and 0.38 or less.

7. The positive electrode material according to claim 1, wherein the mass ratio (P/S) of the phosphorus element to the sulfur element contained in the positive electrode material is 0.03 or more and 0.24 or less.

8. A method for producing a positive electrode material, comprising:
heating a conductive material having pores and elemental sulfur, thereby forming the conductive material supporting the elemental sulfur;
mixing a phosphorus sulfide with the conductive material supporting the elemental sulfur, thereby forming a mixture; and
heating the mixture, thereby forming the positive electrode material.

9. The method for producing the positive electrode material according to claim 8, wherein;
the heating the conductive material having pores and the elemental sulfur is conducted at a temperature ranging from 150° C. to 250° C.; and
the heating the mixture is conducted at a temperature ranging from 170° C. to 500° C.

10. A secondary battery comprising the positive electrode material according to claim 1.

11. The positive electrode material according to claim 2, wherein the coating layer further comprises elemental sulfur and/or a discharge product thereof.

12. The positive electrode material according to claim 2, wherein the BET specific surface area of the conductive material is 1200 m²/g or more and 2500 m²/g or less.

13. The positive electrode material according to claim 2, wherein the mass ratio (P/S) of the phosphorus element to the sulfur element contained in the positive electrode material is 0.03 or more and 0.38 or less.

14. The positive electrode material according to claim 2, wherein the mass ratio (P/S) of the phosphorus element to the sulfur element contained in the positive electrode material is 0.03 or more and 0.24 or less.

15. A secondary battery comprising the positive electrode material according to claim 2.
